(19) United States
(12) Patent Application Publication
(10) Pub. No.: US 2024/0216985 A1
(43) Pub. Date: Jul. 4, 2024

(54) METHOD FOR POSITIONING A SELF-PIERCING-RIVET SETTING TOOL USING A ROBOT

(71) Applicant: KUKA Deutschland GmbH, Augsburg (DE)

(72) Inventor: Burkhard Stimmel, Achmuehle (DE)

(73) Assignee: KUKA Deutschland GmbH, Augsburg (DE)

(21) Appl. No.: 18/558,558

(22) PCT Filed: Mar. 21, 2022
(86) PCT No.: PCT/EP2022/057270

§ 371 Date: Nov. 10, 2023

(30) Foreign Application Priority Data
May 6, 2021 (DE) 10 2021 204 579.0

(51) Int. Cl. B21J 15/02; B21J 15/28; B25J 9/16; G05B 19/4155

(52) U.S. Cl. CPC B21J 15/025; B21J 15/28; B25J 9/1653; G05B 19/4155; G05B 2219/45088

(57) ABSTRACT

A method for positioning a self-piercing-rivet setting tool using a robot includes commanding a robot to position a self-piercing-rivet setting tool in a riveting pose at at least two workpieces joined, and commanding the tool to set a rivet to join the workpieces. During self-piercing riveting, the robot is commanded to change the pose of the tool to at least partially compensate for an elastic deformation induced by the self-piercing rivet. The method may additionally or alternatively include commanding the robot to position the tool in a riveting pose, commanding a self-piercing-rivet movement of the tool with or without setting of a rivet, and manually or sensor-based detecting a change in pose of a die of the tool or of a test element as a result of the self-piercing-rivet movement. The self-piercing-rivet setting tool may be checked and/or a deformation model may be calibrated based on the detected change in pose.

### CROSS-REFERENCE TO RELATED APPLICATIONS

This application is a national phase application under 35 U.S.C. § 371 of International Patent Application No. PCT/EP2022/057270, filed Mar. 21, 2022 (pending), which claims the benefit of priority to German Patent Application No. DE 10 2021 204 579.0, filed May 6, 2021, the disclosures of which are incorporated by reference herein in their entirety.

### TECHNICAL FIELD

The present invention relates to a method for positioning a self-piercing-rivet setting tool by means of a robot and to a computer program or computer program product for carrying out the method.

### SUMMARY

It is the object of the present invention to improve robot-supported self-piercing riveting.

This object is achieved by a method, a system, and computer program or computer program product for performing a method as described herein.

According to one embodiment of the present invention, a method for robot-supported self-piercing riveting comprises the following steps:
commanding a robot to position a self-piercing-rivet setting tool into a riveting pose on at least two workpieces to be joined together; and
commanding the self-piercing-rivet setting tool to set a (self-piercing) rivet for joining the at least two workpieces by means of self-piercing riveting;
wherein during this self-piercing riveting the robot is commanded to change the pose of the self-piercing-rivet setting tool, in particular starting from or relative to the riveting pose, in such a way or with the requirement that this change at least partially compensates, in particular at least partially corrects, an elastic deformation of the self-piercing-rivet setting tool, in particular of at least one die-side leg of the self-piercing-rivet setting tool, caused by the self-piercing riveting.

High process forces often have to be applied during self-piercing riveting, often in the region of, in some cases, well over 20 kN. This can lead to elastic deformations even with solid self-piercing-rivet setting tools, which impair the result of the self-piercing riveting.

On the other hand, such self-piercing-rivet setting tools should often be made as light as possible in order to reduce the robot's load, and/or the legs that carry the riveting punch and die should be made long so that the rivets can be set far from an edge of a component.

By changing the pose of the self-piercing-rivet setting tool accordingly during the self-piercing riveting process using the robot, in one embodiment setting tools that are light(er) and/or comprise longer legs can be used. Additionally or alternatively, in one embodiment the result of the self-piercing riveting can be improved.

Thus, in one embodiment, a compensating movement of the self-piercing-rivet setting tool is commanded or carried out with the aid of the robot during the self-piercing riveting operation and thereby an elastic deformation of the self-piercing-rivet setting tool, in particular of at least one die-side leg of the self-piercing-rivet setting tool, caused by the self-piercing riveting is at least partially compensated or corrected; in particular, this compensating movement is predetermined in such a way programmed in an embodiment.

A change of the pose of the self-piercing-rivet setting tool for at least partial compensation of a self-piercing rivet-induced elastic deformation of the self-piercing-rivet setting tool comprises, in one embodiment, a displacement and/or rotation of the self-piercing-rivet setting tool such that this displacement and/or rotation of the self-piercing-rivet setting tool compensates in whole or in part a bending up of the, in one embodiment C-type, self-piercing-rivet setting tool and/or a displacement and/or rotation of a die and/or axis of the self-piercing-rivet setting tool as a result of a self-piercing rivet-induced elastic deformation of the self-piercing-rivet setting tool, in particular of at least one die-side leg of the self-piercing-rivet setting tool, in one embodiment is directed in the same direction as or opposite this self-piercing rivet-induced bending up of the self-piercing-rivet setting tool or displacement and/or rotation of the die and/or axis of the self-piercing-rivet setting tool. In one embodiment, an amount of a displacement of the die of the self-piercing-rivet setting tool as a result of changing the pose of the self-piercing-rivet setting tool for the at least partial compensation corresponds to at least 25 percent and/or at most 200 percent of an amount of an (uncompensated) displacement of the die as a result of elastic deformation of the self-piercing-rivet setting tool, in particular of the die-side leg, caused by the self-piercing rivet, and/or an amount of a rotation of the die of the self-piercing-rivet setting tool as a result of the change in the pose of the self-piercing-rivet setting tool for the at least partial compensation is at least 25 percent and/or at most 200 percent of an amount of a (non-compensated) rotation of the die as a result of a self-piercing rivet-induced elastic deformation of the self-piercing-rivet setting tool, in particular of the die-side leg, or the change of the pose is commanded in this way or with this requirement, in particular is prespecified. The same applies analogously in one embodiment for an at least partial compensation of an elastic back-shaping of the self-piercing-rivet setting tool as a result of a reduction in a force applied by the self-piercing-rivet setting tool. In one embodiment, changing the pose of the self-piercing-rivet setting tool for at least partial compensation is commanded in such a way or with the requirement that a position and/or orientation of the die of the self-piercing-rivet setting tool during the self-piercing riveting deviates less from the pose of the die or axis in the riveting pose than without compensation or change of the pose of the self-piercing-rivet setting tool.

In one embodiment, the robot is commanded during the self-piercing riveting process on the basis of a deformation model, in particular a mathematical or numerical deformation model, of the self-piercing-rivet setting tool stored in a robot controller.

In one embodiment, the deformation model comprises a direct or indirect assignment between process values of the self-piercing riveting, in particular forces, in particular force curves, displacements, in particular displacement curves, or the like, and poses (and pose changes) of the setting tool for at least partial compensation, for example in tabular or functional form or the like.

Such (deformation) model-supported commanding of the pose change of the self-piercing-rivet setting tool during self-piercing riveting can, in one embodiment, at least partially compensate for elastic deformation of the self-piercing-rivet setting tool caused by self-piercing riveting in a particularly advantageous manner, in particular (more) precisely and/or with (more) process reliability, thereby (further) improving the result of the self-piercing riveting in one embodiment.

In one embodiment, the deformation model is calibrated on the basis of the self-piercing-rivet setting tool type or the individual self-piercing-rivet setting tool, preferably in the manner explained below.

The precision of the compensation can be (further) improved by an individual or self-piercing-rivet setting tool-specific (calibrated) deformation model in one embodiment, and the calibration effort can be reduced by a (calibrated) deformation model according to the type in one embodiment.

In addition or alternatively, the deformation model is parameterized in one embodiment, preferably after calibration, on the basis of the self-piercing riveting to be performed and/or on the basis of the workpieces to be joined.

In one embodiment, the precision of the compensation can be (further) improved and/or the calibration effort can be reduced by an application-specific (parameterized) deformation model.

An embodiment of such method, having at least two stages in one embodiment, with calibration and subsequent parameterization can be illustrated using the simplified example of a deformation model which models the die or the die-side leg of the setting tool as a simple spring. First, the spring stiffness c=F/s can be determined with the riveting pressure force F and the deflection path s of the die and the deformation model can be calibrated in this way. Then, in a second step, a force curve F=F(t) can be specified or determined for a workpiece-specific self-piercing riveting over the displacement or time t. This can then be used to determine a corresponding change in pose of the self-piercing-rivet setting tool, for example Δ(t)=δ·F(t)/c with a correction factor δ≠0 or similar, or to parameterize the deformation model in this way.

In one embodiment, the robot is commanded after the self-piercing riveting operation to further change the pose of the self-piercing-rivet setting tool, preferably on the basis of the stored deformation model and/or in the opposite direction to the change during the self-piercing riveting operation, in such a way or with the requirement that this further change at least partially compensates for, and in particular at least partially corrects, an elastic back-shaping of the self-piercing-rivet setting tool, preferably of at least one die-side leg of the self-piercing-rivet setting tool, which is caused by a reduction in a force applied by the self-piercing-rivet setting tool (during or for self-piercing riveting).

In one embodiment, the self-piercing-rivet setting tool and/or the joined workpieces can thereby be protected.

In one embodiment, changing the pose of the self-piercing-rivet setting tool during self-piercing riveting and/or changing the pose of the self-piercing-rivet setting tool after joining the at least two workpieces comprises at least one (translational) displacement, preferably at least one displacement in or opposite an axis direction, in particular the main axis direction, of a TCP (“tool center point”) or end effector coordinate system for controlling, in particular programming, the robot and/or in or opposite a closing direction, in particular a closing force direction, of the self-piercing-rivet setting tool and/or transversely to the closing (force) direction, in particular in a longitudinal direction of a leg, in particular on the die side, of the self-piercing-rivet setting tool. In particular, a displacement in the closing (force) direction during self-piercing riveting and a displacement against the closing (force) direction after joining or, conversely, a displacement against the closing (force) direction during self-piercing riveting and a displacement in the closing (force) direction after joining can be commanded.

In addition or alternatively, changing the pose of the self-piercing-rivet setting tool during self-piercing riveting and/or after joining the at least two workpieces in one embodiment comprises at least one (rotational) twist, preferably at least one rotation about an axis, in particular the main axis, of a or of the TCP (“Tool Center Point”) or end effector coordinate system for controlling, in particular programming, the robot and/or transversely to the closing, in particular closing force, direction of the self-piercing-rivet setting tool and/or transversely to a longitudinal direction of a leg, in particular on the die side, of the self-piercing-rivet setting tool.

Shifts and rotations in or against or around TCP axes can simplify commanding and/or improve precision in one embodiment. Through the shift in or against the closing (force) direction and rotation about an axis transverse thereto and to the longitudinal direction of the leg, in one embodiment significant parts of the deformation can be compensated for, thereby (further) improving precision. In one embodiment, a deformation can be easily compensated for by displacement, thereby (further) improving precision, and in one embodiment bending deformations can be particularly well compensated for by rotation, thereby (further) improving the result of the self-piercing rivet.

In one embodiment, a method described here comprises the further steps:
commanding the robot to position the self-piercing-rivet setting tool into a further riveting pose;
commanding the self-piercing-rivet setting tool to set a further rivet for joining the at least two workpieces or at least two further workpieces by means of further self-piercing riveting,
wherein also during this further self-piercing riveting, the robot is commanded on the basis of the stored deformation model of the self-piercing-rivet setting tool to change the pose of the self-piercing-rivet setting tool, in particular starting from or relative to the further riveting pose, for at least partial compensation of an elastic deformation, induced by the further self-piercing riveting, of the self-piercing-rivet setting tool, wherein the deformation model is reparameterized on the basis of this further self-piercing riveting to be carried out and/or the workpieces to be joined.

In one embodiment, the precision can thereby be improved and the result of the two self-piercing rivets can thus be improved. An embodiment of such an at least two-stage, in particular at least three-stage process with parameterization of the deformation model for one self-piercing riveting and subsequent reparameterization of the deformation model for the other self-piercing riveting and, if necessary, initial calibration can be illustrated using the simplified example explained above by specifying or determining a different force curve F=F′(t) over the displacement or time t in a third step for another self-piercing riveting and then using this to determine a corresponding change in pose, for example (t=F′(t)/c, or (re)parameterizing the deformation model in this way. and then using this to determine a corresponding pose change, for example Δ(t)=δ·F′(t)/c, or (re)parameterizing the deformation model in this way.

According to one embodiment of the present invention, a method for positioning a self-piercing-rivet setting tool by means of a robot comprises the following steps:
commanding the robot to position the self-piercing-rivet setting tool in a riveting pose, in one embodiment on a test element, in a further embodiment on a test coupon;
commanding a self-piercing riveting movement of the self-piercing-rivet setting tool, in particular on the test element, without or particularly preferably with setting a rivet; and
manual or sensor-based, in one embodiment automated, detection of a change in the pose of the test element as a result of, in particular during, the self-piercing riveting movement or a change in the pose of a die of the self-piercing-rivet setting tool as a result of, in particular during, the self-piercing riveting movement.

In one embodiment, the sensory detection takes place with the aid of one or more optoelectronic sensors and/or position sensors, i.e., in particular optoelectronic position sensors. As a result, in one embodiment the precision can be improved.

According to one embodiment of the present invention, a deformation model is calibrated on the basis of the detected pose change and, in a development, after this calibration a method described herein for robot-assisted self-piercing riveting is carried out with this (thus) calibrated deformation model and with this self-piercing-rivet setting tool or one of the same type, and with this or another robot.

In one embodiment, the precision can be improved by sensory, in particular automated, detection of a change in the pose of the test element or the die, and in one embodiment the apparatus setup can be simplified by manual detection.

In one embodiment, the detection for calibrating the deformation model and the robot-supported self-piercing riveting based on the calibrated deformation model take place at different locations. In one embodiment, this can improve the precision of the calibration, and preferably a stationary measuring setup for sensory, in particular automated, detection can be used, and/or can improve the robot-assisted self-piercing riveting, in particular without a measuring station for calibration.

In addition or as an alternative to calibrating a deformation model, according to one embodiment of the present invention the self-piercing-rivet setting tool can be tested on the basis of the detected pose change and, in a further development, long-term effects such as wear or the like can thereby be detected, in particular monitored. For this purpose, in one embodiment the commanding to position the self-piercing-rivet setting tool in a riveting pose, the commanding of a self-piercing riveting movement of the self-piercing-rivet setting tool, and the detection of a pose change of the (respective) test element or the die as a result of the (respective) self-piercing riveting movement is repeated several times, preferably cyclically. This can again be illustrated using the simplified example explained above: if, for example, the detected pose change increases over several cycles, a change in the setting tool can be detected from this.

In one embodiment, measured values of the sensor-detected pose change are transmitted to a controller of the robot to control the robot and/or calibrate the deformation model. In one embodiment, the control or calibration can thereby be improved.

According to one embodiment of the present invention, a system for positioning a self-piercing-rivet setting tool by means of a robot, in particular for robot-assisted self-piercing riveting, is set up, in one embodiment in hardware and/or in software, in particular by programming, to carry out a method described here.

According to one embodiment of the present invention, a system for robot-assisted self-piercing riveting comprises:
means for commanding a robot to position a self-piercing-rivet setting tool into a riveting pose on at least two workpieces to be joined to one another;
means for commanding the self-piercing-rivet setting tool to set a rivet to join the at least two workpieces by means of self-piercing riveting, and
means for commanding the robot to change the pose of the self-piercing-rivet setting tool for at least partial compensation of an elastic deformation, induced by self-piercing riveting, of the self-piercing-rivet setting tool during this self-piercing riveting.

According to one embodiment of the present invention, a system for positioning a self-piercing-rivet setting tool by means of a robot comprises:
means for commanding the robot to position the self-piercing-rivet setting tool into a riveting pose, in particular on a test element;
means for commanding a self-piercing riveting movement of the self- piercing-rivet setting tool, in particular on the test element, with or without setting a rivet; and
means for manual or sensor-based, in particular automated, detection of a change in the pose of the test element or of a die of the self-piercing-rivet setting tool as a result of the self-piercing riveting movement;

According to one embodiment of the present invention, this system comprises:
means for testing the self-piercing-rivet setting tool on the basis of the detected pose change.

Additionally or alternatively, according to one embodiment of the present invention this system comprises:
means for calibrating a deformation model, in particular the deformation model used in a system for robot-assisted self-piercing riveting described herein.

In one embodiment, one of the above-mentioned systems or its means comprises:
means for commanding the robot during self-piercing riveting on the basis of a stored deformation model of the self-piercing-rivet setting tool, in a further development means for calibrating the deformation model on the basis of the type of self-piercing-rivet setting tool or the individual self-piercing-rivet setting tool and/or for parameterizing on the basis of the self-piercing riveting to be carried out and/or the workpieces to be joined; and/or
means for commanding the robot to further change the pose of the self-piercing-rivet setting tool for the at least partial compensation of an elastic back-shaping of the self-piercing-rivet setting tool as a result of a reduction of a force applied by the self-piercing-rivet setting tool after the self-piercing riveting, in particular on the basis of the stored deformation model; and/or
means for commanding the robot to position the self-piercing-rivet setting tool in a further riveting pose and commanding the self-piercing-rivet setting tool to set a further rivet for joining the at least two workpieces or at least two further workpieces by means of further self-piercing riveting, wherein also during this further self-piercing riveting the robot is commanded on the basis of the stored deformation model of the self-piercing-rivet setting tool to change the pose of the self-piercing-rivet setting tool for at least partial compensation of a self-piercing rivet-induced elastic deformation of the self-piercing-rivet setting tool, wherein the deformation model is reparameterized on the basis of this further self-piercing riveting to be performed and/or the workpieces to be joined in the process; and/or
means for transmitting measured values of the sensor-detected pose change for controlling the robot and/or calibrating the deformation model to a controller of the robot.

A system and/or a means within the meaning of the present invention may be designed in hardware and/or in software, and in particular may comprise at least one data-connected or signal-connected, in particular, digital, processing unit, in particular microprocessor unit (CPU), graphic card (GPU) having a memory and/or bus system or the like and/or one or multiple programs or program modules. The processing unit may be designed to process commands that are implemented as a program stored in a memory system, to detect input signals from a data bus and/or to output output signals to a data bus. A storage system may comprise one or a plurality of, in particular different, storage media, in particular optical, magnetic, solid-state, and/or other non-volatile media. The program may be designed in such a way that it embodies or is capable of carrying out the methods described herein, so that the processing unit is able to carry out the steps of such methods and thus is able to control in particular the robot and/or the self-piercing-rivet setting tool. In one embodiment, a computer program product may comprise, in particular be, a storage medium, in particular computer-readable and/or non-volatile, for storing a program or instructions or with a program stored thereon or with instructions stored thereon. In one embodiment, execution of said program or instructions by a system or controller, in particular a computer or an arrangement of a plurality of computers, causes the system or controller, in particular the computer or computers, to carry out a method described herein or one or more steps thereof, or the program or instructions are adapted to do so.

In one embodiment, one or more, in particular all, steps of the method are performed completely or partially automatically, in particular by the system or its means.

In one embodiment, the system comprises the robot and/or the self-piercing-rivet setting tool and/or a, or the, robot controller.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the invention.

FIG. 1 schematically depicts a system during positioning of a self-piercing-rivet setting tool by means of a robot according to a method of one embodiment of the present invention;

FIG. 2 depicts the system in a further step of the method;

FIG. 3 depicts the system during a robot-assisted self-piercing rivet according to a method according to one embodiment of the present invention;

FIG. 4 depicts the system in a further step of this self-piercing riveting;

FIG. 5 depicts a method according to an embodiment of the present invention; and

FIG. 6 depicts a method according to a further embodiment of the present invention.

### DETAILED DESCRIPTION

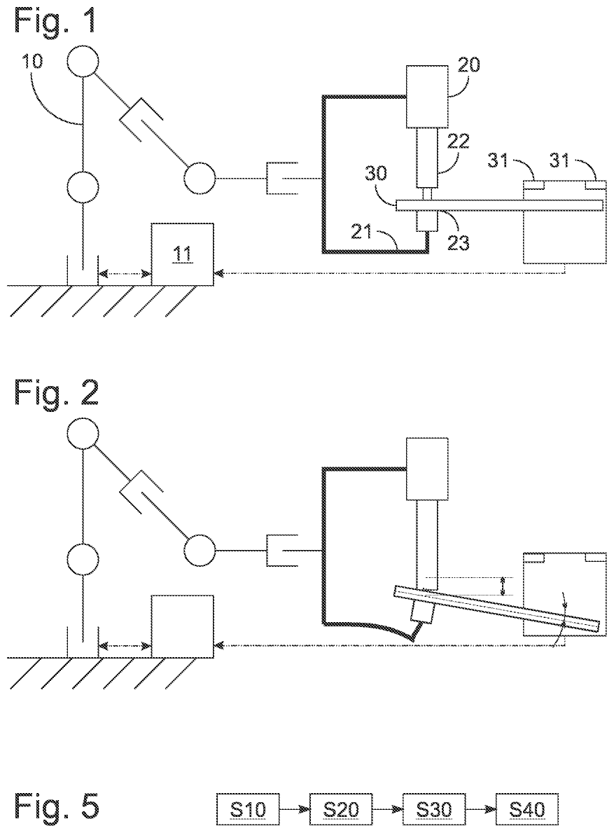

FIG. 1 shows a system or a method step according to an embodiment of the present invention.

The system comprises a robot 10 which guides a self-piercing-rivet setting tool 20 with a leg with a die 23 (“die-side leg”) 21 and a leg with a movable riveting punch 22 for setting self-piercing rivets.

A robot controller 11 commands the robot in such a way that it positions the self-piercing-rivet setting tool 20 in a riveting pose shown in FIG. 1 on a test coupon 30 (FIG. 5: step S10).

Subsequently (FIG. 1→FIG. 2), the robot controller 11 commands a self-piercing riveting movement of the self-piercing-rivet setting tool 20 on the test coupon 30 (FIG. 5: step S20).

As a result of this self-piercing riveting movement, the self-piercing-rivet setting tool 20, in particular its die-side leg 21, is deformed and the pose of the test coupon 30 changes accordingly (see FIG. 2).

This change in pose of the test coupon 30 is detected by a stationary measuring device with sensors 31 and transmitted to the robot controller 11 (FIG. 5: step S30).

Alternatively, the pose change can also be detected manually and entered into the robot controller 11.

Based on this detected pose change, in one embodiment the self-piercing-rivet setting tool 20 is tested (FIG. 5: step S40). For example, the process described above can be repeated cyclically: if the change in pose increases, a change in the self-piercing-rivet setting tool 20 can be detected (therefrom).

FIG. 6 shows a method according to a further embodiment of the present invention. Steps S10-S30 correspond to those described above with reference to FIG. 5.

In this method, a deformation model is calibrated on the basis of the pose change detected in step S30 (FIG. 6: step S100), for example a correlation between process forces, in particular closing forces, and corresponding displacements and/or rotations of the test coupon 30 or displacements and/or rotations of the self-piercing-rivet setting tool 20 that at least partially compensate for these is determined.

Subsequently, when the self-piercing-rivet setting tool 20 is commissioned at a location different from the stationary measuring device, for example in a production line or the like, the stored deformation model calibrated on the basis of the self-piercing-rivet setting tool 20 is parameterized on the basis of a self-piercing riveting to be performed and/or workpieces to be joined in the process (FIG. 6: step S110). If, for example, corresponding displacements or rotations for compensation were determined in step S100 for various closing forces or the like and the deformation model was calibrated in this way, a course of the displacements or rotations for compensation during this self-piercing riveting can now also be determined with a specified closing force curve, and the calibrated deformation model can be parameterized in this way.

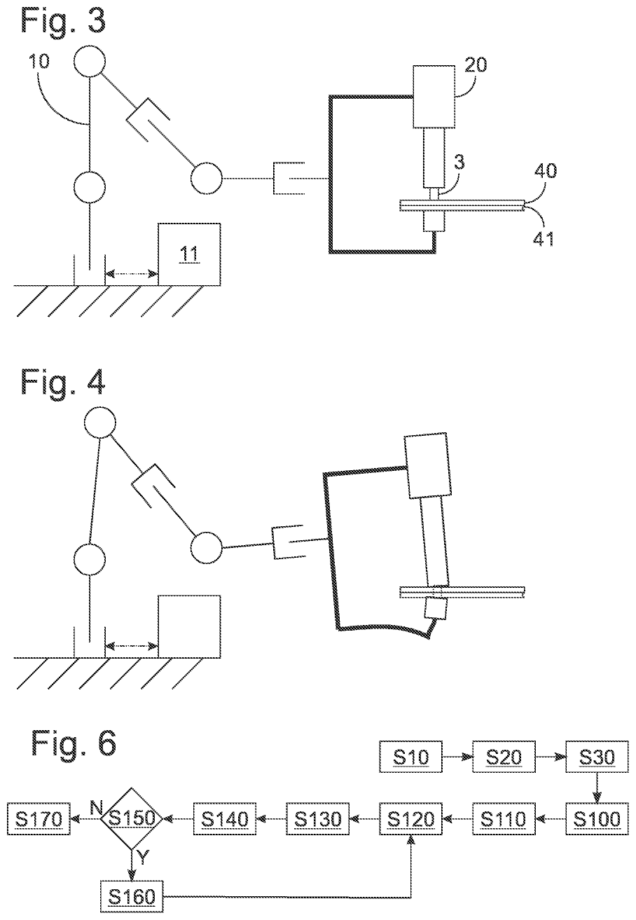

The robot controller 11 now commands the robot such that it positions the self-piercing-rivet setting tool 20 into a rivet pose shown in FIG. 3 on at least two workpieces 40, 41 to be joined to one another (FIG. 6: step S120).

Then (FIG. 3→FIG. 4) the robot controller 11 commands the self-piercing-rivet setting tool to set a rivet 3 to join the at least two workpieces 40, 41 by means of self-piercing riveting (FIG. 6: step S130).

During this self-piercing riveting operation, the robot controller 11 commands the robot 10 on the basis of the stored, calibrated and parameterized deformation model in such a way that it changes the pose of the self-piercing-rivet setting tool 20 during the self-piercing riveting operation in such a way or with the requirement that an elastic deformation of the self-piercing-rivet setting tool 20 caused by the self-piercing riveting operation is at least partially compensated.

This can be illustrated in simplified form by comparing FIGS. 2 and 4: FIG. 2 shows a displacement and rotation of the test coupon 30 as a result of the deformation, caused by the self-piercing rivet, of the self-piercing-rivet setting tool 20, in particular its die-side leg 21, while FIG. 4 shows a corresponding change in the pose of the self-piercing-rivet setting tool 20 by the robot 10. In an embodiment, purely by way of example, for this purpose during or with increasing build-up of a riveting or closing force of the self-piercing-rivet setting tool 20 the self-piercing-rivet setting tool 20 is rotated opposite a bending direction of leg 21, or in FIG. 4 is rotated counterclockwise, in the process being displaced accordingly in the axial direction of the riveting punch and/or transversely thereto, in order in this way to, in particular, at least partially compensate for a bending of the leg 21. For the sake of simplicity, only a bending of the die-side leg 21 is shown or taken into account; alternatively or additionally, a bending of the remaining self-piercing-rivet setting tool 20 or bending in the axial direction of the riveting punch can also be taken into account.

After the self-piercing riveting, the robot controller 11 commands the robot 10 on the basis of the stored, calibrated and parameterized deformation model in such a way that it changes the pose of the self-piercing-rivet setting tool 20 during the (re-)reducing of a force applied by the self-piercing-rivet setting tool in such a way, or with the requirement, that an elastic back-shaping of the self-piercing-rivet setting tool 20 caused by this force reduction is at least partially compensated (FIG. 6: step S140).

If other workpieces are to be joined later by means of further self-piercing riveting (S150: “Y”), the above-mentioned steps S120-S140 are repeated accordingly, the stored deformation model being first reparameterized on the basis of this further self-piercing riveting to be performed and/or the workpieces to be joined in the process (FIG. 6: step S160).

If further self-piercing rivets are to be set on the workpieces 40, 41, the deformation model can also be reparameterized for this purpose if the process parameters of this further self-piercing riveting require this. Similarly, the deformation model parameterized in step S110 can also be reused if necessary. Both of these, as well as the termination of the process in FIG. 6, are indicated in simplified form by a step S170.

Although embodiments have been explained in the preceding description, it is noted that a large number of modifications are possible.

Thus, in particular the change in pose of the die of the self-piercing-rivet setting tool can also be detected or used manually instead of the sensor-based, automated measurement of the change in pose of the test coupon.

It is also noted that the embodiments are merely examples that are not intended to restrict the scope of protection, the applications, and the structure in any way. Rather, the preceding description provides a person skilled in the art with guidelines for implementing at least one embodiment, various changes—in particular with regard to the function and arrangement of the described components—being able to be made without departing from the scope of protection as it arises from the claims and from these equivalent combinations of features.

While the present invention has been illustrated by a description of various embodiments, and while these embodiments have been described in considerable detail, it is not intended to restrict or in any way limit the scope of the appended claims to such de-tail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

### LIST OF REFERENCE SIGNS

10 Robot
11 Robot controller
20 Self-piercing-rivet setting tool
21 Matrix-side leg
22 Rivet punch
23 Die
3 Rivet
30 Test coupon (test element)
31 Sensor
40, 41 Workpiece

What is claimed is:

1-11. (canceled)

12. A method for robot-assisted self-piercing riveting, comprising the steps:
commanding a robot with a robot controller to position a self-piercing-rivet setting tool into a riveting pose on at least two workpieces to be joined to one another;
commanding the self-piercing-rivet setting tool to set a rivet to join the at least two workpieces by self-piercing riveting; and
during the self-piercing riveting, commanding the robot to change the pose of the self-piercing-rivet setting tool for at least partial compensation of an elastic deformation of the self-piercing-rivet setting tool that is induced by the self-piercing riveting.

13. The method of claim 12, wherein commanding the robot to change the pose comprises commanding the robot based on a stored deformation model of the self-piercing-rivet setting tool.

14. The method of claim 13, wherein at least one of:
the deformation model is calibrated on the basis of the type of self-piercing-rivet setting tool or the individual self-piercing-rivet setting tool; or
the deformation model is parameterized based on at least one of the self-piercing riveting to be carried out or the workpieces to be joined.

15. The method of claim 12, further comprising:
after the self-piercing riveting, commanding the robot to further change the pose of the self-piercing-rivet setting tool for at least partial compensation of an elastic back-shaping of the self-piercing-rivet setting tool resulting from a reduction of a force applied by the self-piercing-rivet setting tool.

16. The method of claim 15, wherein commanding the robot to further change the pose comprises commanding the robot based on a stored deformation model of the self-piercing-rivet setting tool.

17. The method of claim 15, wherein at least one of changing the pose of the self-piercing-rivet setting tool or further changing the pose of the self-piercing-rivet setting tool comprises at least one of:
at least one displacement of the self-piercing-rivet setting tool; or
at least one rotation of the self-piercing-rivet setting tool.

18. The method of claim 15, wherein at least one of:
the at least one displacement comprises at least one of:
a displacement in or against a closing direction of the self-piercing-rivet setting tool,
a displacement transverse to the closing direction of the self-piercing-rivet setting tool, or
a displacement in and/or against an axial direction of a tool center point of the robot; or
the at least one rotation comprises:
a rotation about an axis transverse to the closing direction of the self-piercing-rivet setting tool,
a rotation transverse to a longitudinal direction of a leg of the self-piercing-rivet setting tool, or
a rotation about an axis of the tool center point of the robot.

19. The method of claim 13, further comprising:
commanding the robot to position the self-piercing-rivet setting tool into a further riveting pose;
commanding the self-piercing-rivet setting tool, based on the stored deformation model of the self-piercing-rivet setting tool, to set a further rivet in order to join the at least two workpieces, or to join at least two other workpieces by a further self-piercing riveting; and
during the further self-piercing riveting, commanding the robot to change the pose of the self-piercing-rivet setting tool for at least partial compensation of an elastic deformation of the self-piercing-rivet setting tool that is induced by the further self-piercing riveting;
wherein the deformation model is re-parameterized based on at least one of the further self-piercing riveting or on the workpieces to be joined.

20. A method for positioning a self-piercing-rivet setting tool using a robot, the method comprising:
commanding the robot with a robot controller to position the self-piercing-rivet setting tool into a riveting pose;
commanding a self-piercing riveting movement of the self-piercing-rivet setting tool, with or without setting a rivet;
detecting a change in the pose of a die of the self-piercing-rivet setting tool or of the test element resulting from the self-piercing riveting movement; and
based on the detected pose change, at least one of:
testing the self-piercing-rivet setting tool, or
calibrating a deformation model of the self-piercing-rivet setting tool.

21. The method of claim 20, wherein at least one of:
commanding the robot to position the self-piercing-rivet setting tool into the riveting pose comprises commanding the robot to position the self-piercing-rivet setting tool into the riveting pose on a test element, and commanding the self-piercing riveting movement comprises commanding the self-piercing riveting movement of the self-piercing-rivet setting tool on the test element;
detecting a change in the pose of the die comprises automated detecting; or
the method further comprises performing robot-assisted self-piercing riveting using the calibrated deformation model, wherein the pose of the self-piercing-rivet setting tool is changed for at least partial compensation of an elastic deformation of the self-piercing-rivet setting tool that is induced by the self-piercing riveting and based on the deformation model.

22. The method of claim 20, wherein at least one of:
the method further comprises transmitting measured values of detected pose changes to a controller of the robot for at least one of controlling the robot or calibrating the deformation model; or
detecting a change in the pose of a die for calibrating the deformation model, and performing the robot-assisted self-piercing riveting based on the calibrated deformation model, are carried out at different locations.

23. A system for robot-assisted self-piercing riveting, the system comprising:
means for commanding a robot by to position a self-piercing-rivet setting tool into a riveting pose on at least two workpieces to be joined to one another;
means for commanding the self-piercing-rivet setting tool to set a rivet to join the at least two workpieces by self-piercing riveting; and
means for commanding the robot, during the self-piercing riveting, to change the pose of the self-piercing-rivet setting tool for at least partial compensation of an elastic deformation of the self-piercing-rivet setting tool that is induced by the self-piercing riveting.

24. A system for positioning a self-piercing riveting setting tool using a robot, the system comprising:
means for commanding the robot to position the self-piercing-rivet setting tool into a riveting pose;
means for commanding a self-piercing riveting movement of the self-piercing-rivet setting tool, with or without setting a rivet;
means for detecting a change in the pose of a die of the self-piercing-rivet setting tool or of the test element resulting from the self-piercing riveting movement; and
means for at least one of:
testing the self-piercing-rivet setting tool based on the detected pose change, or
calibrating a deformation model of the self-piercing-rivet setting tool.

25. A computer program product for robot-assisted self-piercing riveting, the computer program product comprising program code stored on a non-transitory, computer-readable medium, the program code, when executed on a computer, causing the computer to perform the method of claim 12.
